(19) United States
(12) Patent Application Publication
(10) Pub. No.: US 2026/0192565 A1
(43) Pub. Date: Jul. 9, 2026

(54) LIQUID EJECTION SUBSTRATE AND LIQUID EJECTION HEAD

(71) Applicant: CANON KABUSHIKI KAISHA, Tokyo (JP)

(72) Inventors: TAKAYUKI KAMIMURA, Kanagawa (JP); MASATAKA NAGAI, Kanagawa (JP)

(21) Appl. No.: 19/430,843

(22) Filed: Dec. 23, 2025

(30) Foreign Application Priority Data
Jan. 9, 2025 (JP) 2025-003600

(51) Int. Cl. B41J 2/14; B41J 2/16

(52) U.S. Cl. CPC B41J 2/1433; B41J 2/162; B41J 2/1626; B41J 2/1631; B41J 2/1637; B41J 2002/14411

(57) ABSTRACT

Provided is a liquid ejection substrate including: a base substrate including an energy generation element; and an ejection port forming member having a first surface and a second surface, the ejection port forming member being arranged on the base substrate such that the ejection port overlaps the energy generation element as viewed in a direction orthogonal to the first surface, and being configured to transmit light. A depressed portion having a minimum opening width of at least 1 μm and a depth of not more than 1/2 of a length from the first surface to the second surface is provided on at least one of the first surface and the second surface, and an inclination angle of the depressed portion relative to the surface on which the depressed portion is provided is at least 10°.

### BACKGROUND

### Field of the Technology

The present disclosure relates to a liquid ejection substrate and a liquid ejection head including a liquid ejection substrate.

### Description of the Related Art

A liquid ejection device including a liquid ejection head that ejects a liquid such as ink from a plurality of nozzles is known as a printing device such as a printer having a printing head in which a plurality of nozzle rows are arranged to pressurize a liquid inside a liquid chamber and eject the liquid from ejection ports to outside. In a liquid ejection head, defects such as foreign matter, stains, or scratches on the nozzle forming surface or in the flow path may cause problems such as ejection failures. Therefore, it is preferable to detect and remove these defects through inspection.

Japanese Patent No. 7434865 discloses a liquid ejection head configured of, for instance, a nozzle plate, which serves as a nozzle forming member having nozzle rows, and a flow path plate, which serves as a flow path forming member having a flow path formed therein. In the above-described configuration, shallow and wide depressed portions designed to enhance wiping performance are formed between nozzles on the nozzle forming surface of the liquid ejection head.

In the above-described configuration, when the nozzle forming member is made of a light-transmitting material, it is difficult to distinguish the surface of the nozzle forming member from the opposite surface thereto during an optical external appearance inspection, making it difficult to accurately focus on the respective surfaces. Accordingly, even if a defect is found, it is not possible to easily identify the location of the defect in the nozzle forming member.

### SUMMARY

The present disclosure has been made in view of the above-described problem and aims to provide a liquid ejection head that enables efficient removal of defects.

According to some embodiments, a liquid ejection substrate for use in a liquid ejection head, the liquid ejection substrate comprising: a base substrate having a flow path formed therein, the base substrate including an energy generation element configured to generate energy for ejecting a liquid; and an ejection port forming member having a first surface facing an outside of the liquid ejection substrate and a second surface on an opposite side to the first surface, the second surface facing the base substrate, the ejection port forming member having an ejection port penetrating from the first surface to the second surface, the ejection port forming member being arranged on the base substrate such that the ejection port overlaps the energy generation element as viewed in a direction orthogonal to the first surface, and being configured to transmit light, wherein a depressed portion having a minimum opening width of at least 1 μm and a depth of not more than 1/2 of a length from the first surface to the second surface is provided on at least one of the first surface and the second surface, and an inclination angle of the depressed portion relative to the surface on which the depressed portion is provided is at least 10°.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view illustrating the configuration of a liquid ejection substrate according to a comparative example.

FIG. 2 is a schematic cross-sectional view illustrating the configuration of a liquid ejection substrate according to a first embodiment.

FIG. 3 is a partially enlarged view of the periphery of a depressed portion according to the first embodiment.

FIG. 4 is a schematic cross-sectional view illustrating the configuration of a liquid ejection substrate according to a second embodiment.

FIG. 5 is a partially enlarged view of the periphery of a depressed portion according to the second embodiment.

FIG. 6 is a schematic cross-sectional view illustrating the configuration of a liquid ejection substrate according to a third embodiment.

FIG. 7 is a top view illustrating an example of the configuration of the liquid ejection substrate according to the first embodiment.

FIG. 8 is a view illustrating an example in which the bottom of the depressed portion is formed as a plane.

FIG. 9 is a view illustrating an example in which the bottom of the depressed portion is formed as a plane.

FIG. 10 is a view illustrating an example of a configuration in which the two depressed portions are arranged at positions where they overlap.

FIG. 11 is an exploded perspective view of a liquid ejection head.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments. In addition, not all features described in the following embodiments are essential to solutions provided by the invention.

provided in an element substrate, thereby recording an image on the recording medium, will be described. However, the present disclosure is also applicable to inkjet heads that eject liquids other than ink and to other types of liquid ejection heads.

Note that in this specification, the term “printing” (that may also be referred to as “printing” or “print”) refers not only to forming meaningful information such as characters and graphics, but also to forming information regardless of its meaning. In addition, the term broadly encompasses forming images, designs, patterns, or the like on a recording medium, or processing a medium, regardless of whether the result is manifested in a form perceptible to the human eye.

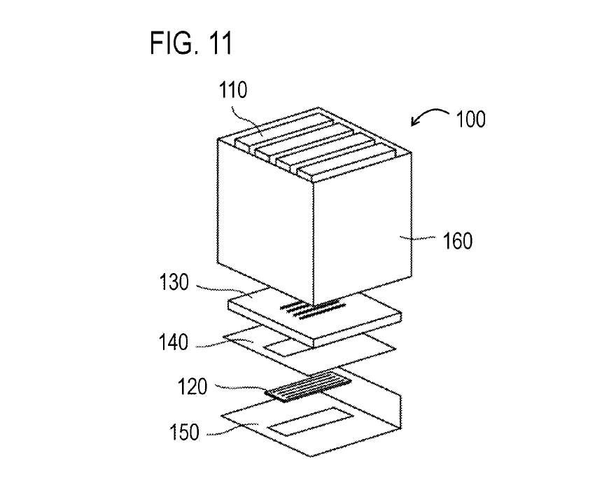

Liquid Ejection Head A description will be given of a liquid ejection head 100, which represents an example of the structure of a liquid ejection head to which the present disclosure is applicable. FIG. 11 is an exploded perspective view of the liquid ejection head 100.

The liquid ejection head 100 includes a plurality of ink tanks 110 that temporarily store ink in the head, and a liquid ejection substrate 120, which serves as a liquid ejection chip that ejects the ink supplied from the ink tanks 110 onto a recording medium. The liquid ejection head 100 further includes a first support member 130, a second support member 140, an electrical wiring member 150, and a housing 160.

In this example, the four ink tanks 110 are provided in the liquid ejection head 100, all of which are accommodated in the housing 160. These ink tanks 110 are capable of storing inks of different colors. The ink stored in each of the ink tanks 110 is supplied to the liquid ejection substrate 120 and then ejected toward a recording medium via a plurality of nozzles formed on the liquid ejection substrate 120.

The first support member 130 is a support member that supports the liquid ejection substrate 120. The first support member 130 is connected to the liquid ejection substrate 120 and the ink tanks 110 and has a flow path formed therein to feed the ink from the ink tanks 110 to the liquid ejection substrate 120.

The second support member 140 is a support member that is connected to the first support member 130 and supports the electrical wiring member 150. The second support member 140 has an opening formed therein to allow the liquid ejection substrate 120 to pass through and is connected to the first support member 130 such that the liquid ejection substrate 120 is positioned within the opening.

The electrical wiring member 150 is an electrical wiring tape that is electrically connected to the liquid ejection substrate 120 and transmits an ejection signal received from the body of the liquid ejection device or the like to the liquid ejection substrate 120 to eject the ink.

Liquid Ejection Substrate Next, a description will be given of the specific configuration of the liquid ejection substrate 120, which serves as a substrate for a liquid ejection head. Hereinafter, a plurality of embodiments and a comparative example will be described. However, configurations common between the embodiments and comparative example are denoted by the same reference numerals, and their descriptions will be appropriately omitted. First, prior to the description of the embodiments of the present disclosure, the comparative example will be described.

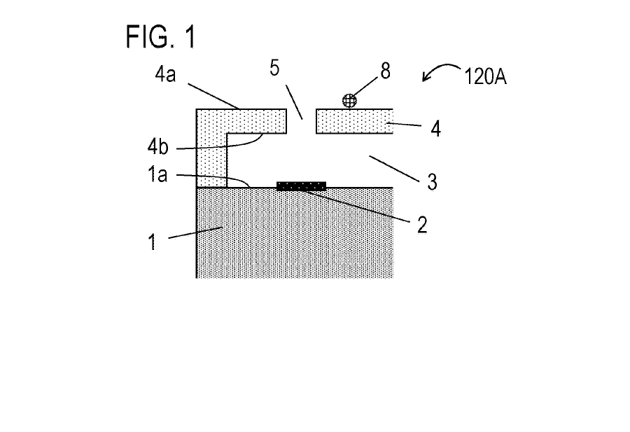

Comparative Example A liquid ejection substrate 120A according to the comparative example will be described. FIG. 1 is a schematic cross-sectional view illustrating the configuration of the liquid ejection substrate 120A according to the comparative example and illustrates a cross section viewed in a direction perpendicular to the liquid ejection direction of the liquid ejection substrate 120A.

The liquid ejection substrate 120A includes a base substrate 1, an energy generation element 2 provided on the base substrate 1, and an ejection port forming member 4 connected to the base substrate 1. Furthermore, the liquid ejection substrate 120A also has an ejection port 5 (nozzle) that ejects the liquid toward a recording medium, and a liquid flow path 3 that is in communication with the ejection port 5.

The base substrate 1 is a substrate having a flow path (not illustrated) formed therein and has a base surface 1a on which the energy generation element 2 and an ejection port forming member 4 are provided. The flow path inside the base substrate 1 is in communication with the liquid flow path 3, and the liquid supplied from the ink tanks 110 to the liquid flow path 3 passes through the inside of the liquid flow path 3. The base surface 1a serves as a flow path surface that constitutes the wall surface of the liquid flow path 3.

The ejection port forming member 4 has a first surface 4a as a front surface and a second surface 4b as a back surface on the side opposite to the first surface 4a. The first surface 4a serves as a surface facing the outside of the liquid ejection head 100 and serves as an ejection port forming surface where the ejection port 5 is opened. The second surface 4b serves as a surface facing the base surface 1a toward the base substrate 1 and serves as a flow path surface that constitutes the wall surface of the liquid flow path 3 together with the base surface 1a. That is, the ejection port forming member 4 serves as a flow path forming member that forms the ejection port 5 and the liquid flow path 3. Furthermore, the ejection port forming member 4 serves as a translucent member made of a light-transmitting material.

The ejection port 5 is formed in the ejection port forming member 4 so as to penetrate from the first surface 4a to the second surface 4b. The ejection port forming member 4 has a plurality of ejection ports 5 formed therein, and the liquid flow path 3 is in communication with each ejection port 5.

The energy generation element 2 is provided corresponding to each of the plurality of ejection ports 5 and generates energy to eject a liquid. When viewed in a direction orthogonal to the base surface 1a (the first surface 4a), the energy generation element 2 is provided at a position where it overlaps the ejection ports 5. When pressure is applied to the liquid filled in the liquid flow path 3 by the energy generation element 2, liquid droplets are ejected from the ejection ports 5. Recording on a recording medium is performed by attaching the liquid droplets to the recording medium. The liquid ejection direction is substantially parallel to the direction orthogonal to the base surface 1a. The energy generation element 2 can be, for example, a piezoelectric element or a heating element (heater) that generates thermal energy to eject ink.

FIG. 1 illustrates an example in which a defect 8, such as foreign matter, a stain, or a scratch, is attached to the first surface 4a. Such a defect 8 may be attached not only to the first surface 4a but also to the second surface 4b. However, when the configurations and shapes of the first surface 4a and the second surface 4b are similar to each other as in the comparative example, the first surface 4a and the second surface 4b are likely to be confused with each other when viewed with an optical external appearance inspection machine. Therefore, even if the defect 8 is found through inspection, it is difficult to determine which of the first surface 4a and the second surface 4b the defect 8 is attached to, causing extra time and labor to remove the defect 8.

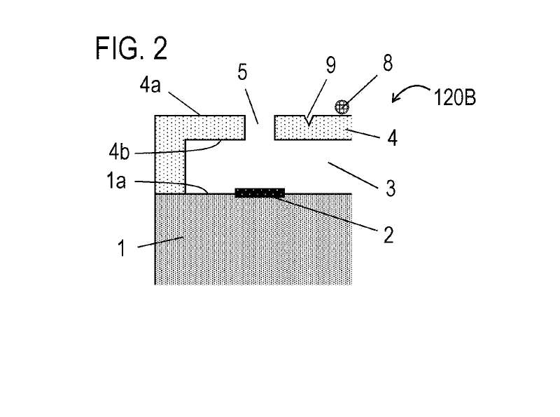

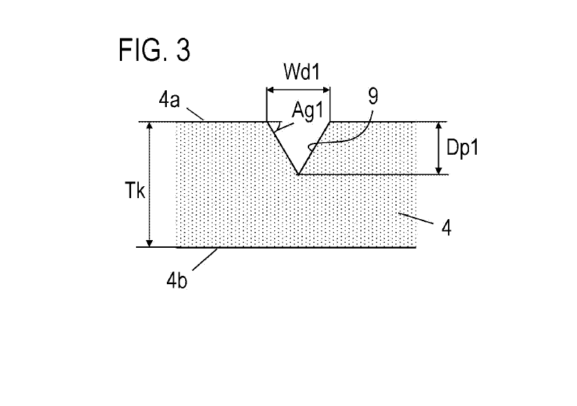

First Embodiment A liquid ejection substrate 120B according to a first embodiment will be described. The first embodiment differs from the comparative example in that a depressed portion 9 is formed on the surface of the liquid ejection substrate 120B. FIG. 2 is a schematic cross-sectional view illustrating the configuration of the liquid ejection substrate 120B according to the first embodiment and illustrates a cross section as viewed in a direction perpendicular to the liquid ejection direction of the liquid ejection substrate 120B. FIG. 3 is a partially enlarged view of the periphery of the depressed portion 9 in FIG. 2.

On the first surface 4a of the ejection port forming member 4 of the liquid ejection substrate 120B, the depressed portion 9, which serves as a recessed structure, is formed. The depressed portion 9 is a groove having a V-shaped cross section and is elongated in the in-plane depth direction of FIG. 2. However, the configuration of the depressed portion 9 is not limited to this. For example, the shape of the depressed portion 9 may be in the form of an inverted quadrangular pyramid, and its opening on the first surface 4a is square. Furthermore, for example, the depressed portion 9 may be formed so as to extend to the ejection port 5. The depressed portion 9 may be formed by, for example, photolithography, dry etching, or the like.

In a configuration in which the depressed portion 9 is provided in the ejection port forming member 4, the depressed portion 9 has a surface formed at a height or angle different from that of the first surface 4a. Therefore, when viewed with an optical external appearance inspection machine, the first surface 4a can be clearly distinguished from the depressed portion 9. That is, the depressed portion 9 can be simply in focus so that the pattern of the depressed portion 9 is clearly visible. By focusing the depressed portion 9, an operator can accurately and easily recognize the position of the first surface 4a. Accordingly, it is possible to definitely determine whether the defect 8 is present on the first surface 4a. In addition, because the possibility of misrecognition due to confusion between the first surface 4a and the second surface 4b is reduced, the position of the defect 8 can be more reliably and easily recognized.

In consideration of the visibility of the depressed portion 9, a width Wd1, which represents the minimum opening width of the depressed portion 9 (the width of the portion of the opening on the installation surface), is preferably set to be larger than the resolution of the camera of an external appearance inspection machine and, specifically, is preferably set to at least 1 μm. Furthermore, in order to facilitate distinction between the first surface 4a and the second surface 4b, a depth Dp1, which represents the depth from the first surface 4a to the lowermost point of the depressed portion 9, is preferably set to be not more than 1/2 of a thickness Tk, which represents the thickness from the first surface 4a to the second surface 4b of the ejection port forming member 4. In addition, in order to enhance the contrast when the depressed portion 9 is seen with an external appearance inspection machine, an inclination angle Ag1, which represents the inclination angle of an inclined surface that forms the groove shape of the depressed portion 9 relative to the first surface 4a, is preferably set to at least 10°. Moreover, because the surface condition of the first surface 4a near the ejection port 5 has a large influence on ejection, the depressed portion 9 is preferably provided in a range within 10 μm from the ejection port 5. Accordingly, relative to an ejection port row in which a plurality of ejection ports 5 are arranged, the same number of depressed portions 9 as the ejection ports 5 or a depressed portion 9 extending in the arrangement direction of the ejection port row is particularly preferably provided.

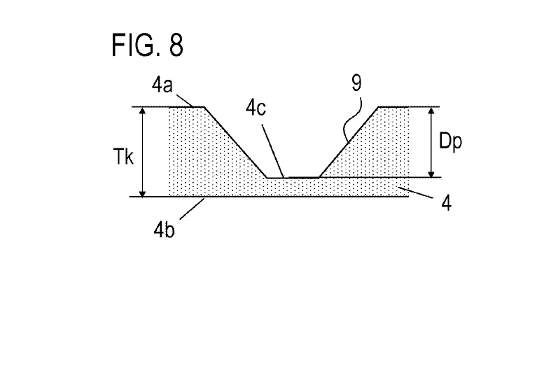

Furthermore, no surface parallel to the first surface 4a is preferably formed on the bottom of the depressed portion 9. FIG. 8 is a view illustrating an example in which the bottom of the depressed portion 9 is formed as a plane 4c. With such a configuration, the plane 4c is in focus when viewed with an optical external appearance inspection machine, and the plane 4c may be confused with the first surface 4a or the second surface 4b. Accordingly, the bottom of the depressed portion 9 is preferably formed as an edge or curved surface.

According to the configuration of the first embodiment, the depressed portion 9 can be in focus during inspection using an optical external appearance inspection machine. Therefore, the position of the first surface 4a can be determined more efficiently and reliably. That is, distinction between the first surface 4a and the second surface 4b can be made more accurately, and the position of the defect 8 can be identified more efficiently. Accordingly, it is possible to determine with high accuracy whether the defect 8 is an object to be repaired (object to be removed) without damaging the ejection port forming member 4 and the like, thereby maintaining the high quality of the liquid ejection head 100 more efficiently.

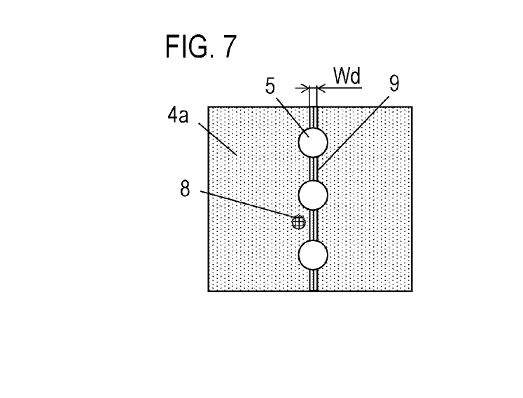

Next, a method for manufacturing the liquid ejection substrate 120B according to the first embodiment will be illustratively described. Specifically, the method for manufacturing the liquid ejection substrate 120B in which the depressed portion 9 extending between the adjacent ejection ports 5 is formed will be described. FIG. 7 is a top view illustrating an example of the configuration of the liquid ejection substrate according to the first embodiment. FIG. 7 illustrates a part of the liquid ejection substrate 120B as viewed from the side of the first surface 4a. Note that the extending direction of the depressed portion 9 in the example of the configuration illustrated in FIG. 7 is different from that in the example of the configuration illustrated in FIG. 2.

In manufacturing the liquid ejection substrate 120B, first, a substrate from which the base substrate 1 is derived was fabricated by forming a flow path inside a silicon substrate and providing the energy generation element 2. The substrate is fabricated so that a plurality of base substrates 1 (liquid ejection substrates 120B) can be cut out from this substrate. Next, on the base surface 1a of the base substrate 1, the mold material of the liquid flow path 3 was formed by patterning and etching using a positive-type resist. Next, the ejection port forming member 4 was coated using a negative-type resist. Then, the ejection ports 5 and the depressed portion 9 were formed individually by exposure and development.

In order to facilitate recognition of the depressed portion 9, the width Wd1 of the depressed portion 9 is preferably set to be larger than the resolution of a camera capturing an image of the depressed portion 9, i.e., at least 1 μm. In this example, the width Wd1 of the depressed portion 9 was set to 2 μm. Furthermore, the thickness Tk of the ejection port forming member 4 from the first surface 4a to the second surface 4b was set to 6 μm. In order to increase distinction between the first surface 4a and the second surface 4b, the depth Dp1 of the depressed portion 9 was set to 1 μm, which is not more than 1/2 of the thickness Tk. In addition, in order to enhance the contrast of the depressed portion 9 when viewed from the side of the first surface 4a, the inclination angle Ag1 of the depressed portion 9 was set to 45°, which is an angle of at least 10°. Furthermore, the depressed portion 9 was formed with a V-shaped cross section having an edge and no plane. In addition, in order to facilitate identification of the surface where the defect 8 is present near the ejection ports 5, which has a large influence on ejection, the depressed portion 9 was formed to extend from one ejection port 5 to an adjacent ejection port 5 over the entire region between the ejection ports 5 as illustrated in FIG. 7. In this example, the same depressed portions 9 are formed between the ejection ports 5.

Next, by exposure to remove the mold material of the liquid flow path 3, the ejection port forming member 4 having the depressed portion 9 transferred onto the first surface 4a was formed. In this example, the ejection port forming member 4 was made of a light-transmitting resin. Thus, the light-transmitting ejection port forming member 4 is provided on the base substrate 1. By providing the ejection port forming member 4 having the depressed portion 9 formed on the silicon substrate, the height of an optical external appearance inspection machine can be adjusted so that the pattern of the depressed portion 9 is clearly visible, thereby enabling identification of a focusing surface (the first surface 4a). Accordingly, the surface where the defect 8 is present can be identified, thereby enabling efficient removal of defects.

After that, the substrate is cut and separated by a dicing saw or the like into chips to complete the liquid ejection substrate 120B. Then, by performing operations such as joining electrical wiring for driving the energy generation element 2 to each liquid ejection substrate 120B and connecting the ink tanks 110 for supplying liquids, the liquid ejection head 100 is completed. As a result of a printing operation performed using the liquid ejection head 100 manufactured by the above method, high-quality ejection characteristics were confirmed.

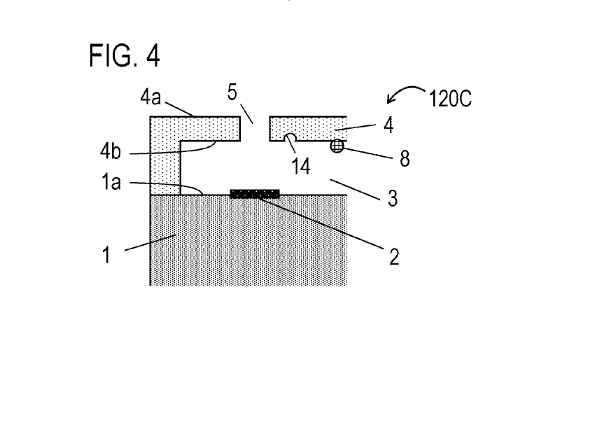

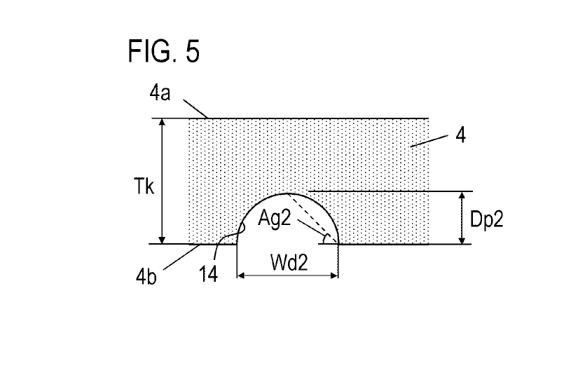

Second Embodiment A liquid ejection substrate 120C according to a second embodiment will be described. The second embodiment differs from the first embodiment in that a depressed portion 14 is formed on the second surface 4b of the ejection port forming member 4 instead of the depressed portion 9. FIG. 4 is a schematic cross-sectional view illustrating the configuration of the liquid ejection substrate 120C according to the second embodiment and illustrates a cross section viewed in a direction perpendicular to the liquid ejection direction of the liquid ejection substrate 120C. FIG. 5 is a partially enlarged view of the periphery of the depressed portion 14 illustrated in FIG. 4.

On the second surface 4b of the ejection port forming member 4 of the liquid ejection substrate 120C, the depressed portion 14, which serves as a recessed structure, is formed. The depressed portion 14 is a hemispherical groove having a hemispherical cross section, and its opening on the second surface 4b is circular. However, the configuration of the depressed portion 14 is not limited to this. For example, the depressed portion 14 may be a groove elongated in the in-plane depth direction of FIG. 4. Furthermore, for example, the depressed portion 14 may be formed so as to extend to the ejection port 5.

In a configuration in which the depressed portion 14 is provided in the ejection port forming member 4, the depressed portion 14 has a surface formed at a height or angle different from that of the second surface 4b. Therefore, when viewed with an optical external appearance inspection machine, the second surface 4b can be clearly distinguished from the depressed portion 14. That is, the depressed portion 14 can be simply in focus so that the pattern of the depressed portion 14 is clearly visible. By focusing the depressed portion 14, an operator can accurately and easily recognize the position of the second surface 4b. Accordingly, it is possible to definitely determine whether the defect 8 is present on the second surface 4b. Furthermore, because the possibility of misrecognition due to confusion between the first surface 4a and the second surface 4b is reduced, the position of the defect 8 can be more reliably and easily recognized.

In consideration of the visibility of the depressed portion 14, a width Wd2, which represents the minimum opening width of the depressed portion 14 (the width of the portion of the opening on the installation surface), is preferably set to be larger than the resolution of the camera of an external appearance inspection machine and, specifically, is preferably set to at least 1 μm. Furthermore, in order to facilitate distinction between the first surface 4a and the second surface 4b, a depth Dp2, which represents the depth from the second surface 4b to the lowermost point of the depressed portion 14, is preferably set to be not more than 1/2 of a thickness Tk, which represents the thickness of the ejection port forming member 4 from the first surface 4a to the second surface 4b. In addition, in order to enhance the contrast when the depressed portion 14 is seen with an external appearance inspection machine, an inclination angle Ag2, which represents the inclination angle of an imaginary line that connects the uppermost point (i.e., the point connected to the second surface 4b) and the lowermost point of the depressed portion 14 relative to the second surface 4b, is preferably set to at least 10°. In addition, because the surface condition of the first surface 4a near the ejection port 5 has a large influence on ejection, the depressed portion 14 is preferably provided in a range within 10 μm from the ejection port 5. Accordingly, for an ejection port row in which a plurality of ejection ports 5 are arranged, the same number of depressed portions 14 as the ejection ports 5 or a depressed portion 14 extending in the arrangement direction of the ejection port row is particularly preferably provided.

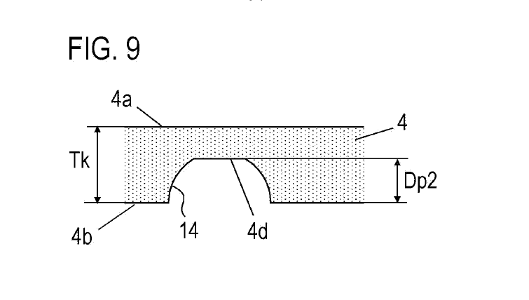

Furthermore, no surface parallel to the second surface 4b is preferably formed on the bottom (i.e., the upper end in FIG. 4) or the like of the depressed portion 14. FIG. 9 is a view illustrating an example in which the bottom of the depressed portion 14 is formed as a plane 4d. With such a configuration, the plane 4d is in focus when viewed with an optical external appearance inspection machine, and the plane 4d may be confused with the first surface 4a or the second surface 4b. Accordingly, the bottom of the depressed portion 14 is preferably formed as an edge or curved surface.

According to the configuration of the second embodiment, the depressed portion 14 can be in focus during inspection using an optical external appearance inspection machine. Therefore, the position of the second surface 4b can be determined more efficiently and reliably. That is, distinction between the first surface 4a and the second surface 4b can be made more accurately, and the position of the defect 8 can be identified more efficiently. Accordingly, it is possible to determine with high accuracy whether the defect 8 is an object to be repaired (object to be removed) without damaging the ejection port forming member 4 and the like, thereby maintaining the high quality of the liquid ejection head 100 more efficiently.

Next, a method for manufacturing the liquid ejection substrate 120C according to the second embodiment will be illustratively described. The manufacturing process before the formation of a plurality of base substrates 1 on a silicon substrate is the same as that in the first embodiment.

Next, on the base surface 1a of the base substrate 1, the mold material of the liquid flow path 3 was formed by patterning and etching using a positive-type resist. Then, particles were sprayed on the surface of the mold material (forming member) of the liquid flow path 3 to form a protruded portion. The protruded portion serves as a structure for forming the depressed portion 14 in a subsequent process.

In order to facilitate recognition of the depressed portion 14, the width Wd2 of the depressed portion 14 is preferably set to be larger than the resolution of a camera capturing an image of the depressed portion 14, i.e., at least 1 μm. In order to increase distinction between the first surface 4a and the second surface 4b, the depth Dp2 of the depressed portion 14 is preferably not more than 1/2 of the thickness Tk (= 6 μm) of the ejection port forming member 4. In addition, in order to enhance the contrast of the depressed portion 14 when viewed from the side of the second surface 4b, the inclination angle Ag2 of the depressed portion 14 is preferably set to at least 10°. In order to satisfy these conditions, in this example, particles having a particle diameter of 2 μm were sprayed on the upper surface of the mold material of the liquid flow path 3. According to this method, a protruded portion for forming the depressed portion 14 having a width Wd2 of 2 μm, a depth Dp2 of 2 μm, and an inclination angle Ag2 of 64° can be provided on the surface (upper surface) of the mold material of the liquid flow path 3. Furthermore, according to this method, the depressed portion 14 can be formed so that it has no plane. In addition, in order to facilitate identification of the surface where the defect 8 is present near the ejection port 5, which has a large influence on ejection, the particles were sprayed so that the protruded portion was formed at least at a position within 10 μm from the ejection port 5.

Next, by exposure to remove the mold material of the liquid flow path 3, the ejection port forming member 4 having the depressed portion 14 transferred onto the second surface 4b was formed. In this example, the ejection port forming member 4 was made of a light-transmitting resin. Thus, the light-transmitting ejection port forming member 4 was provided on the base substrate 1. By providing the ejection port forming member 4 having the depressed portion 14 formed on the silicon substrate, the height of an optical external appearance inspection machine can be adjusted so that the pattern of the depressed portion 14 is clearly visible, thereby enabling the identification of a focusing surface (the second surface 4b). Accordingly, the surface where the defect 8 is present can be identified, thereby enabling efficient removal of defects.

After that, the substrate is cut and separated by a dicing saw or the like into chips to complete the liquid ejection substrate 120C. Then, by performing operations such as joining electrical wiring for driving the energy generation element 2 to each liquid ejection substrate 120C and connecting the ink tanks 110 for supplying liquids, the liquid ejection head 100 is completed. As a result of a printing operation performed using the liquid ejection head 100 manufactured by the above method, high-quality ejection characteristics were confirmed.

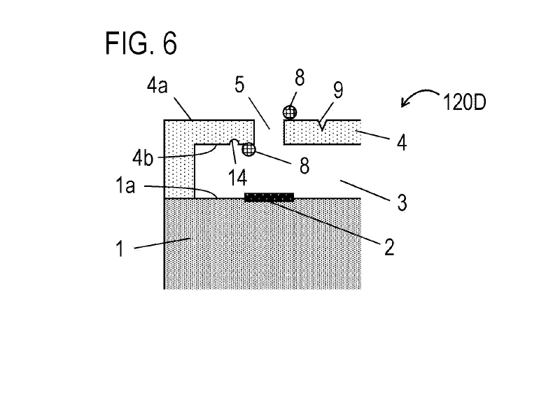

Third Embodiment A liquid ejection substrate 120D according to a third embodiment will be described. The third embodiment differs from the first embodiment in that depressed portions (recessed structures) are formed on both the first surface 4a and the second surface 4b of the ejection port forming member 4. FIG. 6 is a schematic cross-sectional view illustrating the configuration of the liquid ejection substrate 120D according to the third embodiment and illustrates a cross section viewed in a direction perpendicular to the liquid ejection direction of the liquid ejection substrate 120D.

On the first surface 4a of the ejection port forming member 4 of the liquid ejection substrate 120D, the depressed portion 9, which serves as the same recessed structure as that in the first embodiment, is formed. Furthermore, on the second surface 4b of the ejection port forming member 4 of the liquid ejection substrate 120D, the depressed portion 14, which serves as the same recessed structure as that in the second embodiment, is formed.

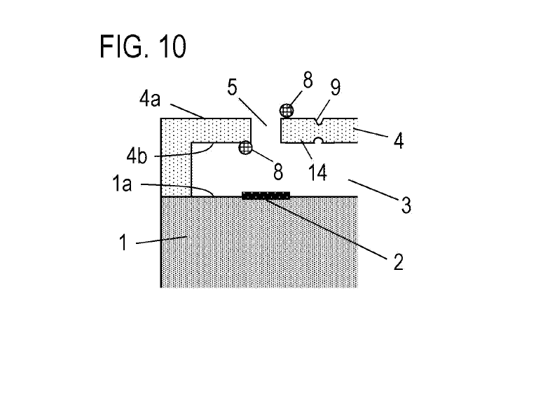

The depressed portions 9 and 14 are preferably arranged at positions where they do not overlap when viewed in a direction orthogonal to the first surface 4a. This arrangement facilitates distinction between the depressed portions 9 and 14 when viewed with an external appearance inspection machine. FIG. 10 is a view illustrating an example of a configuration in which the two depressed portions 9 and 14 are arranged at positions where they overlap when viewed in a direction orthogonal to the first surface 4a. In this case, it is difficult to determine which of the depressed portions 9 and 14 is in focus when viewed with an external appearance visual inspection machine.

Accordingly, in the third embodiment, the depressed portions 9 and 14 are arranged at positions where they do not overlap when viewed in a direction orthogonal to the first surface 4a, as illustrated in FIG. 6. This arrangement facilitates distinction between the depressed portions 9 and 14 when viewed from the side of the first surface 4a. Furthermore, because the opening shapes of the depressed portions 9 and 14 are different from each other, the distinction between the depressed portions 9 and 14 is facilitated.

According to the configuration of the third embodiment, each of the depressed portions 9 and 14 can be in focus during inspection using an optical external appearance inspection machine. Therefore, the positions of the first surface 4a and the second surface 4b can be determined more efficiently and reliably. That is, distinction between the first surface 4a and the second surface 4b can be made more accurately, and the position of the defect 8 can be identified more efficiently. Accordingly, it is possible to determine with high accuracy whether the defect 8 is an object to be repaired (object to be removed) without damaging the ejection port forming member 4 and the like, thereby maintaining the high quality of the liquid ejection head 100 more efficiently.

Note that the depressed portion 9 can be formed in the same manner as in the first embodiment, and the depressed portion 14 can be formed in the same manner as in the second embodiment. Accordingly, the description of the method for manufacturing the liquid ejection substrate 120D and the liquid ejection head 100 according to the third embodiment will be omitted. As a result of a printing operation performed using the liquid ejection head 100 according to the third embodiment, high-quality ejection characteristics were confirmed.

Other Embodiments Note that in the above embodiments, the depressed portions 9 and 14, which serve as recessed structures, are formed on the ejection port forming member 4, but the present invention is not limited to such a configuration. For example, instead of a recessed structure, a protruded structure, such as a protruded portion, may be formed on the ejection port forming member 4. However, even when the protruded structure is provided, the minimum root width of the protruded structure (i.e., the width of a portion connected to the installation surface) is preferably set to at least 1 μm. Furthermore, in order to suppress the protruded portion from having a large influence on ejection or a liquid flow, the height of the protruded portion is preferably set to not more than 1/2 of the thickness Tk of the ejection port forming member 4. Furthermore, in order to enhance the contrast when viewed with an external appearance inspection machine, the inclination angle of the protruded portion relative to the surface on which the protruded portion is provided is preferably set to at least 10°. Furthermore, the apex (tip end) of the protruded portion is preferably formed as an edge or curved surface rather than a plane. Furthermore, the protruded portion is also preferably provided in a range within 10 μm from the ejection port 5.

Note that a method for forming the protruded portion on the ejection port forming member 4 includes, for example, forming in advance a depressed portion corresponding to the protruded portion on a base film for resist (dry film) formation. For example, when forming a negative-type resist for forming the portion having the thickness Tk of the ejection port forming member 4, if the depressed portion corresponding to the protruded portion is provided in advance on the base film, the protruded portion can be formed on the first surface 4a. Furthermore, if the depressed portion corresponding to the protruded portion is provided in advance on the base film for forming a resist (dry film) laminated on another resist (dry film) serving as the layer of the liquid flow path 3, the protruded portion can be provided on the second surface 4b.

As described above, according to a configuration in which at least one of a depressed portion and a protruded portion is provided on at least one of the first surface 4a and the second surface 4b, a surface where a defect is present can be easily identified by an optical external appearance inspection machine or the like, thereby enabling efficient removal of defects.

According to the present disclosure, a liquid ejection head that enables efficient removal of defects can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-003600, filed January 9, 2025, which is hereby incorporated by reference herein in its entirety.

What is claimed is:

1. A liquid ejection substrate for use in a liquid ejection head, the liquid ejection substrate comprising:
a base substrate having a flow path formed therein, the base substrate including an energy generation element configured to generate energy for ejecting a liquid; and
an ejection port forming member having a first surface facing an outside of the liquid ejection substrate and a second surface on an opposite side to the first surface, the second surface facing the base substrate, the ejection port forming member having an ejection port penetrating from the first surface to the second surface, the ejection port forming member being arranged on the base substrate such that the ejection port overlaps the energy generation element as viewed in a direction orthogonal to the first surface, and being configured to transmit light, wherein
a depressed portion having a minimum opening width of at least 1 μm and a depth of not more than 1/2 of a length from the first surface to the second surface is provided on at least one of the first surface and the second surface, and an inclination angle of the depressed portion relative to the surface on which the depressed portion is provided is at least 10°.

2. The liquid ejection substrate according to claim 1, wherein
the depressed portion is provided in a range within 10 μm to be distanced from the ejection port.

3. The liquid ejection substrate according to claim 1, wherein
a bottom of the depressed portion is formed as an edge or curved surface.

4. The liquid ejection substrate according to claim 1, wherein
the depressed portion is provided on each of the first and second surfaces, and the depressed portion on the first surface is positioned so as not to overlap the depressed portion on the second surface as viewed in the direction orthogonal to the first surface.

5. A liquid ejection head comprising:
a liquid ejection substrate including:
a base substrate having a flow path formed therein, the base substrate including an energy generation element configured to generate energy for ejecting a liquid; and
an ejection port forming member having a first surface facing an outside of the liquid ejection substrate and a second surface on an opposite side to the first surface, the second surface facing the base substrate, the ejection port forming member having an ejection port penetrating from the first surface to the second surface, the ejection port forming member being arranged on the base substrate such that the ejection port overlaps the energy generation element as viewed in a direction orthogonal to the first surface, and being configured to transmit light; and
a support member configured to support the liquid ejection substrate, wherein
a depressed portion having a minimum opening width of at least 1 μm and a depth of not more than 1/2 of a length from the first surface to the second surface is provided on at least one of the first surface and the second surface, and an inclination angle of the depressed portion relative to the surface on which the depressed portion is provided is at least 10°.
